(19) United States
(12) Patent Application Publication
(10) Pub. No.: US 2025/0173617 A1
(43) Pub. Date: May 29, 2025

(54) COMPUTER-IMPLEMENTED METHOD FOR COMPENSATING FOR AN UNEVEN DISTRIBUTION IN TRAINING DATA DURING THE TRAINING OF A MACHINE LEARNING ALGORITHM

(71) Applicant: Robert Bosch GmbH, Stuttgart (DE)

(72) Inventors: Nicole Ying Finnie, Renningen (DE); Benedikt Ortelt, Heilbronn (DE); Christoph-Nikolas Straehle, Weil Der Stadt (DE); Ernest-Adrian Scheiber, Budapest (HU); Jan Bernloehr, Kornwestheim (DE); Marc Sons, Oberhausen (DE); Thomas Blank, Freiburg Im Breisgau (DE)

(21) Appl. No.: 18/953,977

(22) Filed: Nov. 20, 2024

(30) Foreign Application Priority Data
Nov. 23, 2023 (DE) 10 2023 211 708.8

(51) Int. Cl. G06N 20/00

(52) U.S. Cl. CPC G06N 20/00

(57) ABSTRACT

A computer-implemented method for compensating for an uneven distribution in training data during the training of a machine learning algorithm. The training data include a plurality of data sets. The machine learning algorithm solves a regression task. The training data have an uneven distribution with regard to their labels. The method includes: defining auxiliary classes for the training data; creating a classification task; ascertaining a classification probability for each auxiliary class; ascertaining a classification loss function for the classification task; weighting the classification loss function; ascertaining an overall loss function; training the machine learning algorithm’ and providing the trained machine learning algorithm.

### CROSS REFERENCE

The present application claims the benefit under 35 U.S.C. § 119 of German Patent Application No. DE 10 2023 211 708.8 filed on Nov. 23, 2023, which is expressly incorporated herein by reference in its entirety.

### FIELD

The present invention relates to the field of training machine learning algorithms, in particular training with incomplete or unevenly distributed training data.

### BACKGROUND INFORMATION

Unevenly distributed training data refers to a situation in which the distribution of values, classes or categories in the training data is not uniform. This means that there is a significant discrepancy between the number of examples for different values or classes, wherein some values and classes occur much more frequently than others. This uneven distribution can occur in various applications and data sets, for example in image recognition, medical diagnosis, fraud detection or other machine learning scenarios.

If the training data are unevenly distributed, this can cause a machine learning model, in particular a neural network, to have difficulty in adequately detecting and predicting rare classes or events, as it tends to focus on the more frequent class due to the uneven distribution. This means that the model tends to achieve better results for the frequent classes, while the rare classes are neglected. Managing and coping with unevenly distributed training data are important challenges in machine learning practice and require specific strategies to compensate for the fact that the model learns what is easy to learn, in particular due to the uneven distribution.

There are methods that attempt to cope with unbalanced classification tasks. However, they cannot be used for regression tasks.

A conventional method for compensating for uneven distributions in training data concerns the determination of a focal loss for the recognition of false predictions with high accuracy. Focal loss was developed to solve uneven distributions with the aid of a background class. When solving regression tasks, for example when determining the speed of objects in road traffic from camera images, most objects would belong to a background class. A prediction for a class that is wrong with a high degree of certainty would be penalized by placing a higher weighting on the corresponding loss.

Another approach is to use a neural network for ordinal regression. The aim is to solve a downstream classification task, with which the classes are ordered and the labels are encoded in accordance with the importance of the classes. A sigmoid cross-entropy loss function can be used to compare the label encoding with the prediction. However, this has a disadvantage. The larger the class, the more “weight” it has in the overall loss. In traditional, downstream regression tasks, such an ordering of the classes is not always present. When converting a regression problem into an ordinal classification, one would assume that the order of the classes corresponds to the importance of the classes, e.g. 5>4>3>2>1>0.

In regression tasks relating to road traffic, for example, the training data frequently have unevenly distributed regression data. This may be due to the fact that most of the objects in the driving scenes have a low speed or are in the range of 100 meters. However, the strength of a camera sensor compared to other modalities, such as lidar or radar sensors, lies in the early recognition of objects from a great distance. For training data with a large uneven distribution, the model has an incentive to learn the unevenly distributed data distribution, i.e. it will perform better with the representative data distribution and worse with the less representative data distribution. Therefore, the model would have to learn to predict a regression task with unevenly distributed training data.

According to the method proposed by the related art, each class designation is encoded with gradually increasing weights.

However, this raises two problems. Not all regression classes are strictly ordered; for example, for traffic classification, the speed class 0 m/s, 1 m/s, 2 m/s, . . . , 50 m/s should have the same encoding as 0 m/s, −1 m/s, −2 m/s, . . . −50 m/s, because −50 m/s and 50 m/s are equally important. However, the sign would mean that another separate subtask is needed to predict the sign. It can also be assumed that 50 m/s is more important than 4 m/s, which is not the case for most regression tasks.

An object of the present invention is to provide a method for training a machine learning algorithm with which uneven distribution in the training data can be compensated for efficiently, so that the influence of the uneven distribution on the regression task is minimized.

This object may achieved by certain features of the present invention.

### SUMMARY

According to a first aspect of the present invention, this object is achieved by a computer-implemented method for compensating for an uneven distribution in training data during the training of a machine learning algorithm. The training data comprise a plurality of data sets that are used to train the machine learning algorithm. The machine learning algorithm solves a regression task by ascertaining an output value for each of the data sets. A regression loss function is ascertained for the regression task. The regression loss function quantifies the quality with which the regression task is solved.

The training data show an uneven distribution with regard to their labels. This means that the distribution of the values to be predicted by the regression task is not uniform in the training data. Thus, there is a considerable discrepancy between the number of examples for different values, wherein some values occur much more frequently than others.

According to an example embodiment of the present invention, the method comprises the following steps:
defining auxiliary classes for the training data;
creating a classification task for assigning the data sets to the auxiliary classes and carrying out the classification task with the regression task;
determining a classification probability for each auxiliary class, wherein the classification probability indicates whether a data set is correctly assigned to the particular class;
ascertaining a classification loss function for the classification task;
weighting the classification loss function with the classification probabilities for each class to a weighted classification loss function;
ascertaining an overall loss function from the regression loss function and the weighted classification loss function for training the machine learning algorithm;
training the machine learning algorithm with the overall loss function; and
providing the trained machine learning algorithm.

A machine learning algorithm is an algorithm that was developed in order to automatically recognize patterns and relationships in data and to make predictions or decisions. It is created through the training with existing data and can then be applied to new, unknown data in order to generate predictions or classifications.

The categorization of the data sets into auxiliary classes is effected prior to training. In particular, the auxiliary classes are selected so that they categorize data sets into groups with regard to uneven distribution. Due to this additional separation, an additional factor is made available to the model underlying the machine learning algorithm, which is used to carry out the training.

In particular, creating the classification task can comprise converting the labels of the data sets into a schema corresponding to the auxiliary classes.

For example, the labels of the data sets can comprise the speed or distance of objects recognized in a video. The conversion can then mean, for example, that the data sets are provided with an additional label that is derived from the existing label. For example, objects with different speeds can be divided into speed classes, for example “slow” with 0 km/s to 25 km/s, “moderate” with 25 km/s to 50 km/h and “fast” with 50+ km/s. In another example, the data sets are divided into “near” with a distance of up to 10 m, “medium” with 10 m to 50 m and “far” with 50+ m distance.

However, the auxiliary classes can also be defined abstractly. The parameter by which the auxiliary classes are defined does not need to correspond to a known or frequently used variable.

For example, the categorization into auxiliary classes can take place on the basis of a quotient that represents the ratio of two physical variables, but has no meaningful significance outside the machine learning algorithm.

The classification probability is used to ascertain how likely it is that a data set will be assigned to a particular class.

As with every subtask of a model, a loss function is also ascertained for the classification of the data sets with regard to the auxiliary classes. This classification loss function is multiplied by the classification probability for each class, in order to take into account the influence of the frequency of assignment of the data sets to the auxiliary classes on the calculation of the loss function.

An overall loss function is ascertained from the regression loss function and the weighted classification loss function, which quantifies the quality of the model. The model can then be trained with the overall loss function. Since the weighted classification loss function is included in the overall loss function, the uneven distribution in the training data can be compensated for or at least partially offset when training the model. This achieves the task of the present invention.

In the final step, the trained machine learning algorithm can be provided so that it can be used for the intended regression task. The classification of the processed data sets and the associated auxiliary classes is no longer required in the trained machine learning algorithm.

In one example embodiment of the present invention, the machine learning algorithm comprises a linear model, decision trees, a support vector machine or a neural network.

A machine learning algorithm can take various forms, such as linear models, decision trees, support vector machines, neural networks and many others. It is optimized by learning from the training data in that it recognizes patterns and rules in order to make the best possible predictions or classifications for new data.

The effectiveness of a machine learning algorithm depends on various factors, including the quality and quantity of the training data, the choice of the algorithm, the model configuration, and the assessment of the model on the basis of evaluation metrics. The model can be continuously improved and optimized in order to maximize accuracy and performance.

The linear regression model assumes a linear relationship between a dependent variable and one or more independent variables and is used in order to make predictions about continuous values.

Support vector machines (SVM) is a model that is used for classification or regression and recognizes patterns in the data. It searches for the optimal separation between different classes or attempts to adapt a continuous function to the data.

Decision trees are a model that creates decision rules in the form of a tree diagram. It categorizes the data based on attributes and makes predictions or classifications possible.

A probabilistic model is Naive Bayes, which is based on Bayes' theorem and is used for classification. It assumes that attributes are independent of one another and calculates the probability of a particular class based on the given attributes.

Neural networks refer to models that are preferably used for processing images or other grid-based data. The architecture of a neural network comprises multiple nodes, neurons, or nodes, arranged in layers.

In one example embodiment of the present invention, the machine learning algorithm comprises a convolutional neural network.

A convolutional neural network (CNN) is a special type of artificial neural network generally developed for tasks in the field of image processing and pattern recognition, although it is also used in other fields, such as speech processing. It is characterized by the use of convolution operations, which serve to extract attributes from the input data.

The main components of a CNN are convolutional layers. These layers are responsible for applying convolution operations to the input data. Convolutions allow the network to recognize attributes, such as edges, texture and other local patterns in the data. Furthermore, a convolutional neural network can comprise pooling layers and fully connected layers.

Pooling layers serve to reduce the spatial dimension of the attributes and increase calculation efficiency. Max-pooling or average-pooling methods are typically used here. Fully connected layers are positioned at the end of the network and serve for classification or regression. They combine the extracted attributes in order to generate a final output.

Convolutional neural networks have proven to be extremely powerful for tasks, such as image classification, object recognition, face recognition and segmentation. They have the ability to learn attributes hierarchically, which means they can learn from simple attributes, like edges, up to more complex concepts, like shapes and objects in the data. This makes them particularly useful for problems where the spatial structure of the data is important.

In one example embodiment of the present invention, the machine learning algorithm is trained to ascertain a parameter for each data set.

Machine learning algorithms that only need to ascertain one parameter for each data set have several advantages compared to models that need to perform a plurality of tasks simultaneously or sequentially. So-called single-task models are generally simpler and have fewer parameters. This leads to a more efficient calculation and a lower demand for computing resources. They are easier to train and optimize. Since single-task models are geared towards a specific task, they often converge more quickly during training. The model can focus on the attributes and patterns that are relevant for this one task.

Furthermore, single-task models are generally easier to interpret, since they have clear assignments between input and output. This is particularly important in applications, such as medical diagnosis. With multi-task models that perform a plurality of tasks simultaneously or consecutively, the different tasks can interfere with one another or disrupt one another. By contrast, single-task networks are less susceptible to such interference.

In one example embodiment of the present invention, the machine learning algorithm is used in a vehicle or autonomous robot unit and the parameter is the speed of objects in the surrounding area of the vehicle or autonomous robot unit.

Recognizing the speed of objects in the vicinity of the vehicle or robot unit is an essential contribution to controlling them. Objects, in particular other vehicles and/or robot units, can also move in the surrounding area. If a central position and collision check does not take place, the vehicles and/or robot units are dependent on their perception to recognize all objects that could potentially be dangerous to them or that cross their path and thus pose a risk of collision.

Due to the prediction of the speeds of the objects, movement vectors of the objects can preferably be ascertained, with which the movement of the objects can be predicted for the future. In particular, the prediction of the movement can be carried out in a subsequent step or in a separate machine learning algorithm for each detected object.

In one example embodiment of the present invention, the classification loss function is ascertained using a cross-entropy loss function.

The cross-entropy loss function is a frequently used mathematical function in machine learning theory, in particular in the field of supervised learning. This function is often used to measure the error or difference between the predicted probability distributions and the actual probability distributions, in particular in classification tasks.

In a classification task, the task is to train a model to classify input data into different classes or categories. The cross-entropy loss function helps to ascertain how well the predictions of the model match the actual classes.

In one example embodiment of the present invention, the cross-entropy loss function is a softmax function.

The softmax function, also known as the softmax activation function, is a mathematical function that is widely used for machine learning algorithms and in particular in multi-class classification. The softmax function is used to generate a probability distribution across a plurality of classes or categories based on a set of raw values or activations.

The softmax function takes a vector of real numbers as input and converts it into a probability distribution. It generates a probability distribution with which all probabilities lie between 0 and 1 and add up to 1. This makes them particularly suitable for classification tasks with which the model is to calculate a probability for each possible class. As a rule, the class with the highest probability is used as the prediction of the model. In an advantageous way, the softmax function normalizes the output of the machine learning algorithm.

In one example embodiment of the present invention, the auxiliary classes divide the possible results of the regression task into groups.

In this example embodiment of the present invention, both the regression and classification tasks are aimed at predicting the same attribute. It can be assumed that the learned weighting parameters are homogeneous in the loss landscape, that is, the gradient that helps the classification task would also help the main regression task, since both learn to predict the same attribute.

With multi-task learning, gradient conflicts between a plurality of tasks can often be observed. An auxiliary classification task, which takes on a small part of the overall losses, can help the main regression task to compensate for these gradient conflicts. Under this assumption, the auxiliary classification learns to compensate for the unbalanced regression task with little or no observed gradient clashes.

In one example embodiment of the present invention, the class loss function is normalized.

Advantageously, a normalized class loss function is easier to interpret and easier to process.

In one example embodiment of the present invention, the class loss function and the regression loss function are weighted differently when ascertaining the overall loss function.

Depending on how large the uneven distribution in the training data is, the classification loss function should have more or less influence on the overall loss function. Preferably, the weights of the regression loss function and the classification loss function are trainable hyperparameters, so that the weights are adjusted according to the uneven distribution in the training data when training the machine learning algorithm.

In one example embodiment of the present invention, the machine learning algorithm is trained to solve further tasks and further loss functions of these tasks are used when ascertaining the overall loss function.

So-called multi-task models can solve a plurality of tasks in parallel or one after the other. This can be used, for example, to predict not only the speed of objects, but also their movement in the near future. Therefore, a multi-task model can have a superordinate task and a plurality of subtasks, wherein the regression task constitutes one such subtask.

In such a multi-task model, the other tasks should be taken into account in the overall loss function, in particular if the results of the subtasks influence or even depend on one another. In an advantageous way, a machine learning algorithm can be used to solve tasks that go beyond mere parameter prediction by means of an overall loss function that takes into account the loss functions of other tasks.

In a further aspect, the present invention relates to a computer program having program code in order to perform a method as described above when the computer program is executed on a computer.

In a further aspect, the present invention relates to a computer-readable data carrier having program code of a computer program in order to perform a method as described above when the computer program is executed on a computer.

In a further aspect, the present invention relates to a system for training a machine learning algorithm, wherein the system is designed to perform a method as described above.

In summary, the present invention discloses a method for compensating for an uneven distribution in training data during the training of a machine learning algorithm, a computer program for performing the method, a computer-readable medium containing program code of the computer program and a system for performing the method.

The described embodiments and developments can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWING

The FIGURE is intended to impart further understanding of the embodiments of the present invention. The FIGURE illustrates embodiments and, in connection with the description, serves to explain principles and concepts of the present invention.

Other embodiments and many of the mentioned advantages are apparent from the FIGURE. The illustrated elements of the FIGURE are not necessarily shown to scale relative to one another.

FIG. 1 schematically shows the sequence of a method according to one example embodiment of the present invention.

### DETAILED DESCRIPTION OF EXAMPLE EMBODIMENTS

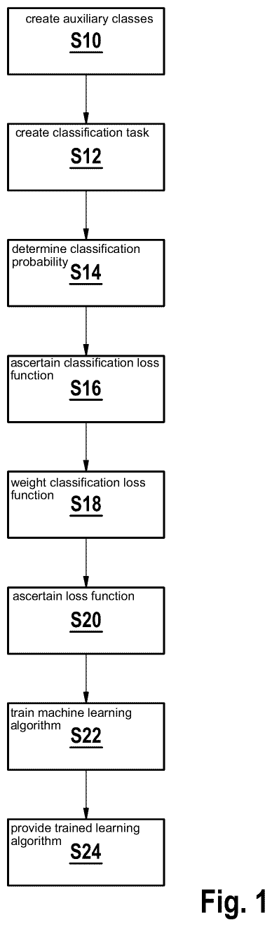

FIG. 1 schematically shows the sequence of a method according to one embodiment of the present invention.

In the first step S10, auxiliary classes are created for the training data. The auxiliary classes support the solution of the regression task by making a kind of pre-sorting of the data sets possible. For example, if the regression task of the machine learning algorithm is to ascertain the speed of objects from a camera image, the auxiliary classes can categorize the objects into different speed levels. The levels can comprise, for example, “fast” at more than 50 km/h, “moderate” at 25 km/h to 50 km/h and “slow” at less than 25 km/h. Other categorizations are also possible. The selection of auxiliary classes and their limits should be adapted to the regression problem to be solved.

The auxiliary classes should preferably be selected so that they can divide the training data with regard to the uneven distribution. Back in the example where the regression task is to predict a speed, the auxiliary classes would preferably be defined to divide the data sets so that a range of the over-represented group and a range of the under-represented group are formed. In embodiments, there may also be ranges in between or outside.

In step S12, a classification task is created. In particular, creating the classification task can comprise adding corresponding labels for the auxiliary classes to the training data. Furthermore, an independent section, for example a sub-network, can be created as part of a neural network that solves the classification task. The training is then carried out so that the classification task is solved together with the regression task.

In step S14, a classification probability is determined. The classification probability indicates how frequently the data sets were assigned to the correct class. From this, a probability is derived that indicates the correct classification for each auxiliary class.

In step S16, a classification loss function is ascertained. The classification loss function serves to optimize the classification task. In the subsequent step S18, the classification loss function is weighted so that the weights reflect the frequency of the data sets in the particular auxiliary classes. This compensates for the fact that one or more classes contain significantly more data sets than other auxiliary classes.

In step S20, an overall loss function is ascertained for the machine learning algorithm. The overall loss function is ascertained from the regression loss function and the classification loss function. If the machine learning algorithm solves further tasks, the loss functions for solving these tasks are also used to ascertain the overall loss function.

In step S22, the machine learning algorithm is trained with the overall loss function. This step comprises, in particular, backpropagation or adaptation of the hyperparameters and weights used by the machine learning algorithm in order to solve the regression task and possibly other tasks.

In embodiments, steps S14 to S22 are repeated until the machine learning algorithm correctly solves the regression task for the data sets from the training data and compensation is made for the uneven distribution in the training data. The trained machine learning algorithm is then provided (S24).

What is claimed is:

1. A computer-implemented method for compensating for an uneven distribution in training data during training of a machine learning algorithm, wherein the training data include a plurality of data sets with which the machine learning algorithm is trained, wherein the machine learning algorithm solves a regression task by ascertaining an output value for each of the data sets, wherein a regression loss function is ascertained for the regression task, wherein the training data have an unequal distribution with regard to their labels, wherein the method comprises the following steps:
defining auxiliary classes for the training data;
creating a classification task for assigning the data sets to the auxiliary classes and carrying out the classification task with the regression task;
determining a classification probability for each auxiliary class of the auxiliary classes, wherein the classification probability indicates whether a data set is correctly assigned to the auxiliary class;
ascertaining a classification loss function for the classification task;
weighting the classification loss function with the classification probabilities for each auxiliary class to a weighted classification loss function;
ascertaining an overall loss function from the regression loss function and the weighted classification loss function for training the machine learning algorithm;
training the machine learning algorithm with the overall loss function; and
providing the trained machine learning algorithm.

2. The computer-implemented method according to claim 1, wherein the machine learning algorithm includes a linear model or decision trees or a support vector machine or a neural network.

3. The computer-implemented method according to claim 1, wherein the machine learning algorithm includes a convolutional neural network.

4. The computer-implemented method according to claim 1, wherein the machine learning algorithm is trained to ascertain a parameter for each data set of the data sets.

5. The computer-implemented method according to claim 4, wherein the machine learning algorithm is used in a vehicle or autonomous robot unit and wherein the parameter is a speed of objects in a surrounding area of the vehicle or an autonomous robot.

6. The computer-implemented method according to claim 1, wherein the classification loss function is ascertained using a cross-entropy loss function.

7. The computer-implemented method according to claim 6, wherein the cross-entropy loss function is a softmax function.

8. The computer-implemented method according to claim 1, wherein the auxiliary classes divide possible results of the regression task into groups.

9. The computer-implemented method according to claim 1, wherein the classification loss function is normalized.

10. The computer-implemented method according to claim 1, wherein the classification loss function and the regression loss function are weighted differently when ascertaining the overall loss function.

11. The computer-implemented method according to claim 1, wherein the machine learning algorithm is trained to solve further tasks and wherein further loss functions of the further tasks are used when ascertaining the overall loss function.

12. A non-transitory computer-readable data carrier on which are stored program code of a computer program for compensating for an uneven distribution in training data during training of a machine learning algorithm, wherein the training data include a plurality of data sets with which the machine learning algorithm is trained, wherein the machine learning algorithm solves a regression task by ascertaining an output value for each of the data sets, wherein a regression loss function is ascertained for the regression task, wherein the training data have an unequal distribution with regard to their labels, the program code, when executed by a computer, causing the computer to perform the following steps:
defining auxiliary classes for the training data;
creating a classification task for assigning the data sets to the auxiliary classes and carrying out the classification task with the regression task;
determining a classification probability for each auxiliary class of the auxiliary classes, wherein the classification probability indicates whether a data set is correctly assigned to the auxiliary class;
ascertaining a classification loss function for the classification task;
weighting the classification loss function with the classification probabilities for each auxiliary class to a weighted classification loss function;
ascertaining an overall loss function from the regression loss function and the weighted classification loss function for training the machine learning algorithm;
training the machine learning algorithm with the overall loss function; and
providing the trained machine learning algorithm.

13. A system for training a machine learning algorithm, wherein the system is configured to compensate for an uneven distribution in training data during training of a machine learning algorithm, wherein the training data include a plurality of data sets with which the machine learning algorithm is trained, wherein the machine learning algorithm solves a regression task by ascertaining an output value for each of the data sets, wherein a regression loss function is ascertained for the regression task, wherein the training data have an unequal distribution with regard to their labels, wherein the system is configured to:
define auxiliary classes for the training data;
create a classification task for assigning the data sets to the auxiliary classes and carrying out the classification task with the regression task;
determine a classification probability for each auxiliary class of the auxiliary classes, wherein the classification probability indicates whether a data set is correctly assigned to the auxiliary class;
ascertain a classification loss function for the classification task;
weight the classification loss function with the classification probabilities for each auxiliary class to a weighted classification loss function;
ascertain an overall loss function from the regression loss function and the weighted classification loss function for training the machine learning algorithm;
train the machine learning algorithm with the overall loss function; and
provide the trained machine learning algorithm.
